(19) United States
(12) Patent Application Publication
(10) Pub. No.: US 2007/0195013 A1
(43) Pub. Date: Aug. 23, 2007

(54) PLASMA DISPLAY APPARATUS AND DRIVING METHOD OF PLASMA DISPLAY APPARATUS

(76) Inventor: Seonghak Moon, Seoul (KR)

Correspondence Address: KED & ASSOCIATES, LLP, P.O. Box 221200, Chantilly, VA, 20153-1200, US

(21) Appl. No.: 11/672,247

(22) Filed: Feb. 7, 2007

(30) Foreign Application Priority Data
Feb. 7, 2006 (KR) 10-2006-0011634

(51) Int. Cl. G09G 3/20; G09G 3/00

(52) U.S. Cl. 345/55

(57) ABSTRACT

A plasma display apparatus comprises a plasma display panel, an energy storing unit, a first driver, and a second driver. The plasma display panel includes a first electrode and a second electrode. The energy storing unit supplies a first voltage and a second voltage, or the second voltage. The first driver supplying or recovering an energy corresponding to the first voltage or the second voltage of the energy storing unit through the first electrode during an address period. The second driver supplying or recovering the energy corresponding to the second voltage of the energy storing unit through the second electrode during a sustain period. A level of the first voltage is less than a level of the second voltage.

This Nonprovisional application claims priority under 35 U.S.C. § 119(a) on Patent Application No. 10-2006-0011634 filed in Korea on Feb. 7, 2006 the entire contents of which are hereby incorporated by reference.

### BACKGROUND

1. Field

This document is related to a plasma display apparatus and a driving method of the plasma display apparatus.

2. Description of the Related Art

A plasma display panel comprises a front panel and a rear panel, and Discharge cells are between the front panel and the rear panel. Discharge gas comprising Xe and one of Ne, He and a mixture gas of Ne and He, is filled in the discharge cells. Pixels for displaying an image include the discharge cells. For example, one pixel includes a red discharge cell, a green discharge cell and a blue discharge cell.

When a discharge is generated in the plasma display panel, the discharge gas generates vacuum ultraviolet rays, vacuum ultraviolet rays excite a phosphor formed between barrier ribs, and then the phosphor emits light.

A driving voltage is supplied to an electrode of the plasma display panel. The driving voltage generates a reset discharge, an address discharge and a sustain discharge.

### SUMMARY

In one aspect, a plasma display apparatus comprises a plasma display panel including a first electrode and a second electrode, an energy storing unit supplying a first voltage and a second voltage, or the second voltage, a first driver supplying or recovering an energy corresponding to the first voltage or the second voltage of the energy storing unit through the first electrode during an address period and a second driver supplying or recovering the energy corresponding to the second voltage of the energy storing unit through the second electrode during a sustain period, wherein a level of the first voltage is less than a level of the second voltage.

The energy storing unit may include a capacitor, and the capacitor may supply the second voltage.

The energy storing unit may include a plurality of capacitors, at least one of the plurality of capacitors may supply the second voltage, and the remaining capacitors except at least one of the plurality of capacitors may supply the first voltage.

The energy storing unit may include a first capacitor, a second capacitor, and a third capacitor, the first capacitor and the second capacitor may be connected in serial, the third capacitor may be connected in parallel to the first capacitor and the second capacitor, and the first electrode driver may be connected to a common node of the first capacitor and the second capacitor.

The energy storing unit may include a plurality of capacitors, at least one of the plurality of capacitors may supply the second voltage, the remaining capacitors except at least one of the plurality of capacitors may supply the first voltage, and the first electrode driver may supply or recover the energy corresponding to the first voltage through the first electrode and may supply the second voltage to the first electrode.

The second electrode may include at least of a scan electrode or a sustain electrode.

In another aspect, a plasma display apparatus comprises a plasma display panel including a first electrode and a second electrode, an energy storing unit supplying a first voltage and a second voltage greater, or the first voltage, a first driver supplying or recovering an energy corresponding to the first voltage or the second voltage of the energy storing unit through an inductor and the first electrode during an address period; and a second driver supplying or recovering the energy corresponding to the second voltage of the energy storing unit through the second electrode during a sustain period, wherein a level of the first voltage is less than a level of the second voltage.

The first electrode driver may include a first switch and a data driver, the first switch may be connected between the energy storing unit and the inductor, and may form a supplying path and a recovering path of the energy when the first switch is turned on, and the data driver may be connected to the inductor, and may supply or recover the energy corresponding to the first voltage or the second voltage through the first electrode.

The energy storing unit may include a capacitor, the capacitor may supply the second voltage corresponding to the energy supplied or recovered through the first electrode driver, the first driver may include a first switch and a data driver, the first switch may be connected between the capacitor and the inductor and forms a supplying path of the energy and a recovering path when the first switch is turned on, and the data driver may be connected to the inductor, and may supply or recover the energy through the first electrode.

The energy storing unit may include a plurality of capacitors, at least one of the plurality of capacitors may supply the second voltage, the remaining capacitors except at least one of the plurality of capacitors may supply the first voltage, the first electrode driver may supply or recover the energy corresponding to the first voltage through the first electrode and may supply the first voltage to the first electrode, the first electrode driver may include a first switch and a data driver, the first switch may be connected between the remaining capacitors and an inductor, and may form a supplying path of the energy and a recovering path of the energy when the first switch is turned on, and the data driver may be connected to the inductor and may supply or recover the energy corresponding to the first voltage through the first electrode.

The first electrode driver may further include a second switch, and the second switch may supply a data voltage, supplied by an outside voltage source, to the first electrode through the data driver.

The first electrode driver may further include a second switch, and the second switch may supply the second voltage, supplied by at least one, to the first electrode through the data driver.

The energy storing unit may include a first capacitor, a second capacitor, and a third capacitor, the first capacitor and the second capacitor may be connected in serial, the third capacitor may be connected in parallel to the first capacitor and the second, and the first electrode driver may be connected to a common node of the first capacitor and the second capacitor.

The rest capacitors except at least one of the plurality of capacitors may include a first capacitor connected to the first electrode driver, and a second capacitor connected to the first capacitor, and a capacitance of the second capacitor may be greater than a capacitance of the first capacitor.

In still another aspect, a driving method of a plasma display apparatus including an energy storing unit, a first electrode and a second electrode, comprises supplying or recovering an energy corresponding to a first voltage or second voltage supplied by the energy storing unit through the first electrode during an address period and supplying or recovering the energy corresponding to the second voltage supplied by the energy storing unit through the second electrode during a sustain period, wherein a level of the first voltage is less than a level of the second voltage.

The driving method may further comprise supplying the energy corresponding to the second voltage to the first electrode, supplying a constant voltage to the first electrode, recovering the energy corresponding to the second voltage from the first electrode to the energy storing unit, and supplying a ground level voltage to the first electrode during the address period.

The driving method may further comprise supplying the energy corresponding to the first voltage to the first electrode, supplying a constant voltage to the first electrode, recovering the energy corresponding to the first voltage from the first electrode to the energy storing unit, and supplying a ground level voltage to the first electrode during the address period.

The driving method may further comprise supplying the energy corresponding to the first voltage to the first electrode, supplying the second voltage to the first electrode, recovering the energy corresponding to the first voltage from the first electrode to the energy storing unit, and supplying a ground level voltage to the first electrode during the address period.

### BRIEF DESCRIPTION OF THE DRAWINGS

The embodiment will be described in detail with reference to the following drawings in which like numerals refer to like elements.

FIG. 1 illustrates a plasma display apparatus according to an embodiment;

FIG. 2 illustrates an example of a circuit of an energy storing unit, a first electrode driver, a second electrode driver, and a second electrode driver in FIG. 1;

FIG. 3 illustrates another example of a circuit of an energy storing unit, a first electrode driver, a second electrode driver, and a second electrode driver in FIG. 1; and

FIG. 4 illustrates still another example of a circuit of an energy storing unit, a first electrode driver, a second electrode driver, and a second electrode driver in FIG. 1.

### DETAILED DESCRIPTION OF PREFERRED EMBODIMENTS

Embodiments will be described in a more detailed manner with reference to the drawings.

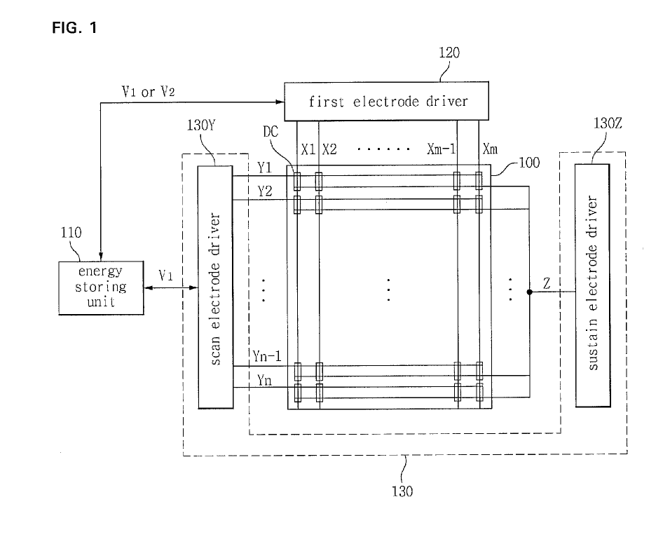

As illustrated in FIG. 1, a plasma display apparatus according to an embodiment includes a plasma display panel 100, an energy storing unit 110, a first electrode driver 120, and a second electrode driver 130.

The plasma display panel 100 includes a first electrode and a second electrode. In FIG. 1, the first electrode may be an address electrode X1 to Xm, and the second electrode may be at least one of a scan electrode Y1 to Yn or a sustain electrode Z1 to Zn. The address electrode X1 to Xm crosses the scan electrode Y1 to Yn and the sustain electrode Z1 to Zn. A region where the address electrode X1 to Xm crosses the scan electrode Y1 to Yn and the sustain electrode Z1 to Zn corresponds to one discharge cell DC.

The energy storing unit 110 a first voltage V1 and a second voltage V2, or the second voltage V2. A level of the first voltage V1 is less than a level of the second voltage V2.

In the embodiment, when the energy storing unit 110 supplies the second voltage V2 to the address electrode X1 to Xm during an address period, and supplies the second voltage V2 to the scan electrode Y1 to Yn and the sustain electrode Z1 to Zn during a sustain period, a level of a data voltage and a level of a half of a highest voltage of the sustain pulse may substantially be a level of the second voltage. The data voltage is a highest voltage of the data pulse.

When the energy storing unit 110 supplies the first voltage V1 to the address electrode X1 to Xm during the address period and supplies the second voltage V2 to the scan electrode Y1 to Yn and the sustain electrode Z1 to Zn during the sustain period, the level of the data voltage may be less than the level of the highest voltage of the sustain pulse.

The data pulse of the address period is for selecting a discharge cell which will be emitting light. The sustain pulse of the sustain period makes the selected discharge cell emit light.

The first driver 120 supplies or recovers an energy corresponding to the first voltage V1 or the second voltage V2 of the energy storing unit 110 through the first electrode such as the address electrode X1 to Xm during an address period.

The second driver 130 supplies or recovers the energy corresponding to the second voltage of the energy storing unit 110 through the second electrode such as the scan electrode Y1 to Yn or the sustain electrode Z1 to Zn during a sustain period. In the embodiment, the second electrode driver 130 may include a scan electrode driver 130Y driving the scan electrode Y1 to Yn, and a sustain electrode driver 130Z driving the sustain electrode Z1 to Zn.

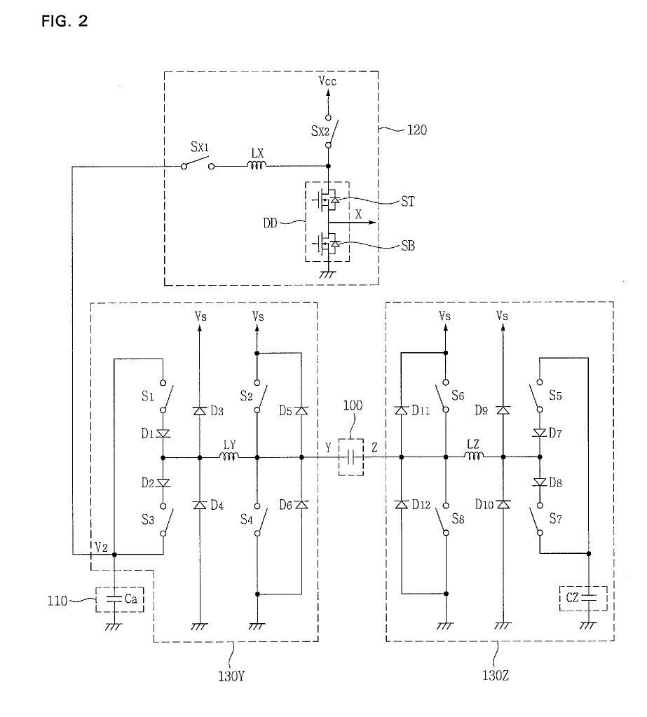

As illustrated in FIG. 2, the energy storing unit 110 includes a capacitor Ca, and, the capacitor Ca supplies a second voltage V2. A level of the second voltage V2 corresponds to a half of a level of a sustain voltage Vs.

The first driver 120 supplies or recovers an energy corresponding to the second voltage V2 of the energy storing unit 110 through an inductor LX and an address electrode X during an address period. A first electrode driver 120 includes a first switch SX1, a second switch SX2 and a data driver DD. The first switch SX1 is connected between the energy storing unit 110 and the inductor LX, and forms a supplying path and a recovering path of the energy when the first switch SX1 is turned on. The second switch SX2 a data voltage Vcc supplied by an outside voltage source (not shown) to the first electrode X. A data driver DD is connected to the inductor LX, and supplies or recovers the energy corresponding to the second voltage V2 through the first electrode X.

When the first switch SX1 and a top switch ST of the data driver DD, the energy corresponding to the second voltage V2 of the energy storing unit 110 is supplied to the first electrode X through the first switch SX1, the inductor LX and the top switch ST. Accordingly, a voltage of the first electrode X increases to two times the second voltage V2.

When the second switch SX2 and the top switch ST are turned on, and the first switch SX1 and the bottom switch SB are turned off, the data voltage Vcc of the outside voltage source is supplied to the first electrode X.

When the first switch SX1 and the top switch ST of the data driver DD are turned on, the energy corresponding to the second voltage V2 is recovered to the capacitor Ca of the energy storing unit 110 through the first electrode X, the top switch ST, the inductor LX and the first switch SX1.

When the bottom switch SB of the data driver DD is turned on, and the first switch SX1, the second switch SX2 and the top switch ST are turned off, a ground level voltage is supplied to the first electrode X.

Each of the scan electrode driver 130Y and the sustain electrode driver 130Z alternately supplies sustain pulses to the second electrodes Y and Z during the sustain period. When the scan electrode driver 130Y supplies the sustain pulse, a switch S8 remains in a turn-on state. When the sustain electrode driver 130Z the sustain pulse, a switch S4 of the scan electrode driver 130Y remains in a turn-on state.

A diode D1 to a diode D12 cut off currents flowing from cathode to anodes of the first diode D1 to the eighth diode D8

A switch S1, a switch S2, a switch S3, and a switch S4 turn on in the order named, and then the scan electrode driver 130Y a sustain pulse to a scan electrode Y. When any one of the switches S1 to S4 is turned on, the remaining switches except the turned on switch are turned off.

A switch S5, a switch S6, a switch S7, and a switch S8 turn on in the order named, and then the scan electrode driver 130Z a sustain pulse to a scan electrode Y. When any one of the switches S5 to S8 is turned on, the remaining switches except the turned on switch are turned off.

Inductors LY and LZ of the scan electrode driver 130Y and the sustain electrode driver 130Z form a resonance when one of the switch S1, the switch S3, the switch S5 or the switch S7 is turned on. The capacitor Ca of the energy storing unit 110 supplies or recovers the energy corresponding to the second voltage through the second electrode Y. A capacitor CZ of the sustain electrode driver 130Z supplies or recovers the energy corresponding to the second voltage V2 through the second electrode Z.

Because the scan electrode driver 130Y and the first electrode driver 120 of FIG. 2 use the capacitor Ca of the energy storing unit 110 in common, the plasma display apparatus of the embodiment can increase an energy efficiency and decrease the number of parts of circuits.

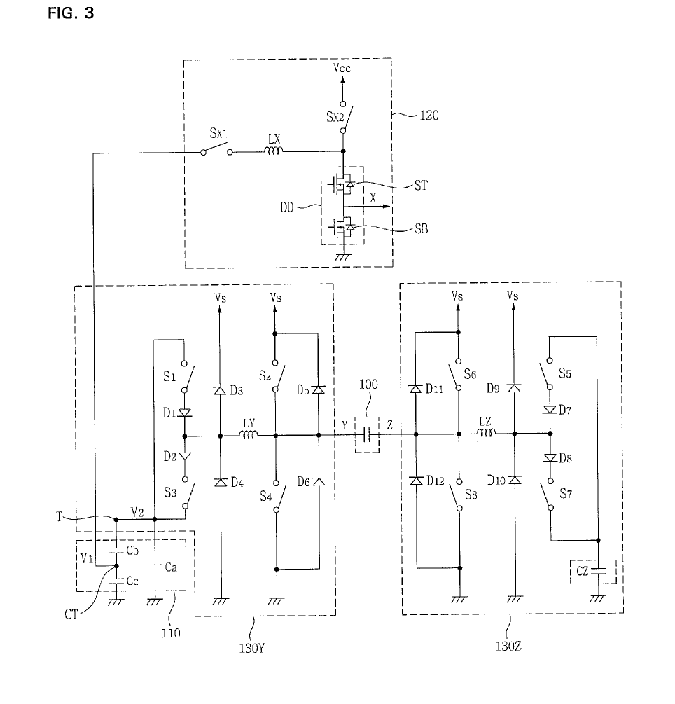

As illustrated in FIG. 3, the plasma display apparatus according to the embodiment includes a plasma display panel 100, an energy storing unit 110, a first electrode driver 120 and a second electrode driver 130.

The energy storing unit 110 includes a plurality of capacitors, at least one of the plurality of capacitors supplies the second voltage V2, and the remaining capacitors except at least one of the plurality of capacitors supply the first voltage V1.

For example, the energy storing unit 110 includes a first capacitor Cb, a second capacitor Cc and a third capacitor Ca. The first capacitor Cb and the second capacitor Cc are connected in serial, the third capacitor Ca is connected in parallel to the first capacitor Cb and the second Cc. The first electrode driver 120 is connected to a common node of the first capacitor Cb and the second capacitor Cc. The third capacitor Ca supplies the second voltage V2. The first capacitor Cb and the second capacitor Cc supply the first voltage V1. The first capacitor Cb and the second capacitor Cc forms the first voltage V1 by dividing the second voltage formed by the third capacitor Ca. Accordingly, a level of the first voltage V1 is less than a level of the second voltage V2.

A capacitance of the second capacitor Cc may be greater than a capacitance of the first capacitor Cb. For example, when the sustain voltage Vs is 180 V, and a data voltage Vcc is 80 V, a voltage of one terminal T of the first capacitor Cb is 90 V, and a voltage of a common terminal CT of the second capacitor Cc is 40 V. Because a voltage between one terminal T and the common terminal CT is 50 V, the capacitance of the second capacitor Cc is greater than the capacitance of the first capacitor Cb.

A structure of the first electrode driver 120 of FIG. 3 is the same as a structure of the first electrode driver 120 of FIG. 2.

When the first switch SX1 and the top switch ST of the data driver DD are turned on, the energy corresponding to the first voltage V1 formed by the first capacitor Cb and the second capacitor Cc, is supplied to the first electrode X through the first switch SX1, the inductor LX and the top switch ST. Accordingly, a voltage of the first electrode X increases to two times the first voltage V1.

When the second switch SX2 and the top switch ST are turned on and the first switch SX1 and the bottom switch SB are turned off, the data voltage Vcc supplied the outside voltage source is supplied to the first electrode X through the data driver DD.

When the first switch SX1 and the top switch ST of the data driver DD are turned on and the second switch SX2 and the bottom switch SB are turned off, the energy corresponding to the second voltage V1 is recovered to the second capacitor Cc through the first electrode X, the top switch ST, the inductor LX and the first switch SX1.

When the bottom switch SB of the data driver DD is turned on and the first switch SX1, the second SX2 and the top switch ST are turned off, the ground level voltage is supplied to the first electrode X.

An operation of the scan electrode driver 130Y and the sustain electrode driver 130Z is the same as the circuit of FIG. 2, a detailed description of the operation of the scan electrode driver 130Y and the sustain electrode driver 130Z in FIG. 3 is omitted.

Because the first electrode driver 120 and the second electrode driver 130 of FIG. 3 use the energy storing unit 110 in common, the plasmai display apparatus according to the embodiment can increase an energy efficiency and decrease the number of parts of the circuit.

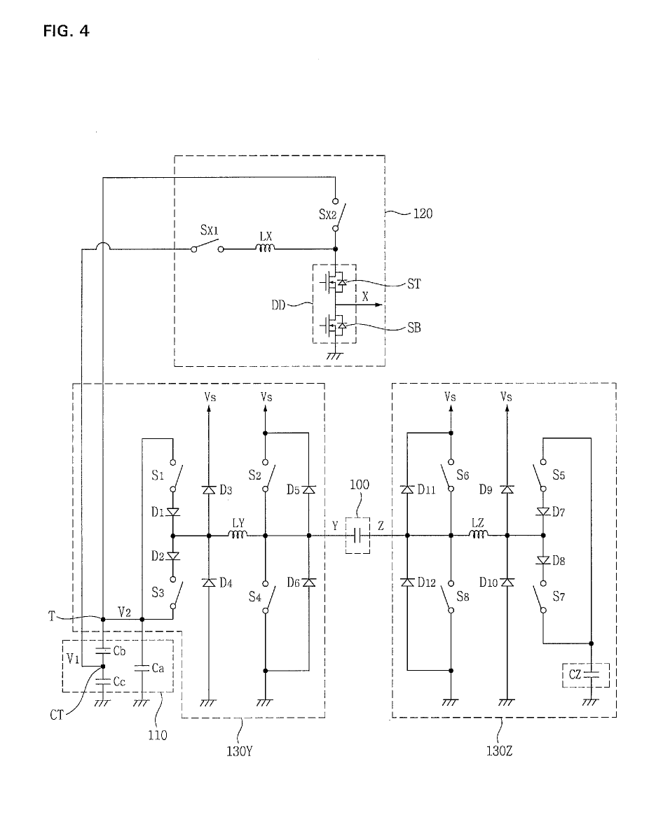

As illustrated in FIG. 4, the plasmai display apparatus according to the embodiment includes a plasma display panel 100, an energy storing unit 110, a first electrode driver 120 and a second electrode driver 130.

Because a structure of the plasma display panel 100 and the second electrode driver 130 are the same as circuits of FIG. 2 and FIG. 3, a detailed description of the plasma display panel 100 and the second electrode driver 130 is omitted.

The energy storing unit 110 of FIG. 4 includes a plurality of capacitors, at least one of the plurality of capacitors supplies the second voltage V2, and the remaining capacitors except at least one of the plurality of capacitors supply the first voltage V1. The first electrode driver 120 supplies or recovers an energy corresponding to the first voltage V1 through the first electrode X, and supplies the second voltage V2 to the first electrode X.

The first electrode driver 120 includes a first switch SX1, a second switch SX2, and a data driver DD. The first switch SX1 is connected between the remaining capacitors and an inductor LX, and forms a supplying path and a recovering path of the energy corresponding to the first voltage when the first switch is turned on. The data driver DD is connected to the inductor LX and supplies or recovers the energy corresponding to the first voltage through the first electrode X. The second switch SX2 supplies the second voltage V2, supplied by at least one of the plurality of the capacitors, to the first electrode X through the data driver DD.

For example, the energy storing unit 110 includes a first capacitor Cb, a second capacitor Cc, and a third capacitor Ca. Because a connection of the first capacitor Cb, the second capacitor Cc, and the third capacitor Ca is the same as the connection of them of FIG. 3, a detailed description of the connection of them is omitted.

A common terminal CT of the first capacitor Cb and the second capacitor Cc is connected the first switch SX1, and the second switch SX2 is one terminal T of the first capacitor Cb.

Accordingly, in the circuit of FIG. 3, the voltage of the first electrode X increases to two times of the first voltage V1, and the data voltage Vcc is supplied to the first electrode X by the outside voltage source. In the circuit of FIG. 4, the second voltage V2 supplied by the third capacitor Ca of the energy storing unit 110, is supplied to the first electrode.

Because the scan electrode driver 130Y and the first electrode driver 120 use the energy storing unit 110 in common, the plasma display apparatus according to the embodiment decreases the number of parts of the circuit.

Embodiment in FIG. 1 to FIG. 4, the scan electrode driver 130Y and the first electrode driver 120 use the energy storing unit 110 in common. The sustain electrode driver 130Z and the first electrode driver 120 can also use the energy storing unit 110 in common.

The foregoing embodiments and advantages are merely exemplary and are not to be construed as limiting the present invention. The present teaching can be readily applied to other types of apparatuses. The description of the foregoing embodiments is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures. Moreover, unless the term “means” is explicitly recited in a limitation of the claims, such limitation is not intended to be interpreted under 35 USC 112(6).

What is claimed is:

1. A plasma display apparatus comprising:
a plasma display panel including a first electrode and a second electrode;
an energy storing unit supplying a first voltage and a second voltage, or the second voltage;
a first driver supplying or recovering an energy corresponding to the first voltage or the second voltage of the energy storing unit through the first electrode during an address period; and
a second driver supplying or recovering the energy corresponding to the second voltage of the energy storing unit through the second electrode during a sustain period, wherein a level of the first voltage is less than a level of the second voltage.

2. The plasma display apparatus of claim 1, wherein
the energy storing unit includes a capacitor, and the capacitor supplies the second voltage.

3. The plasma display apparatus of claim 1, wherein
the energy storing unit includes a plurality of capacitors,
at least one of the plurality of capacitors supplies the second voltage, and
the remaining capacitors except at least one of the plurality of capacitors supply the first voltage.

4. The plasma display apparatus of claim 3, wherein
the energy storing unit includes a first capacitor, a second capacitor, and a third capacitor,
the first capacitor and the second capacitor are connected in serial,
the third capacitor is connected in parallel to the first capacitor and the second capacitor, and
the first electrode driver is connected to a common node of the first capacitor and the second capacitor.

5. The plasma display apparatus of claim 1, wherein
the energy storing unit includes a plurality of capacitors,
at least one of the plurality of capacitors supplies the second voltage,
the remaining capacitors except at least one of the plurality of capacitors supply the first voltage, and
the first electrode driver supplies or recovers the energy corresponding to the first voltage through the first electrode and supplies the second voltage to the first electrode.

6. The plasma display apparatus of claim 1, wherein
the second electrode includes at least of a scan electrode or a sustain electrode.

7. A plasma display apparatus comprising:
a plasma display panel including a first electrode and a second electrode;
an energy storing unit supplying a first voltage and a second voltage greater, or the first voltage;
a first driver supplying or recovering an energy corresponding to the first voltage or the second voltage of the energy storing unit through an inductor and the first electrode during an address period; and
a second driver supplying or recovering the energy corresponding to the second voltage of the energy storing unit through the second electrode during a sustain period, wherein
a level of the first voltage is less than a level of the second voltage.

8. The plasma display apparatus of claim 7, wherein
the first electrode driver includes a first switch and a data driver,
the first switch is connected between the energy storing unit and the inductor, and forms a supplying path and a recovering path of the energy when the first switch is turned on, and
the data driver is connected to the inductor, and supplies or recovers the energy corresponding to the first voltage or the second voltage through the first electrode.

9. The plasma display apparatus of claim 7, wherein
the energy storing unit includes a capacitor,
the capacitor supplies the second voltage corresponding to the energy supplied or recovered through the first electrode driver,
the first driver includes a first switch and a data driver,
the first switch is connected between the capacitor and the inductor and forms a supplying path of the energy and a recovering path when the first switch is turned on, and
the data driver is connected to the inductor, and supplies or recovers the energy through the first electrode.

10. The plasma display apparatus of claim 7, wherein
the energy storing unit includes a plurality of capacitors,
at least one of the plurality of capacitors supplies the second voltage,
the remaining capacitors except at least one of the plurality of capacitors supply the first voltage,
the first electrode driver supplies or recovers the energy corresponding to the first voltage through the first electrode and supplies the first voltage to the first electrode,
the first electrode driver includes a first switch and a data driver,
the first switch is connected between the remaining capacitors and an inductor, and forms a supplying path of the energy and a recovering path of the energy when the first switch is turned on, and
the data driver is connected to the inductor and supplies or recovers the energy corresponding to the first voltage through the first electrode.

11. The plasma display apparatus of claim 10, wherein
the first electrode driver further includes a second switch, and
the second switch supplies a data voltage, supplied by an outside voltage source, to the first electrode through the data driver.

12. The plasma display apparatus of claim 10, wherein
the first electrode driver further includes a second switch, and
the second switch supplies the second voltage, supplied by at least one, to the first electrode through the data driver.

13. The plasma display apparatus of claim 10, wherein
the energy storing unit includes a first capacitor, a second capacitor, and a third capacitor,
the first capacitor and the second capacitor are connected in serial,
the third capacitor is connected in parallel to the first capacitor and the second, and
the first electrode driver is connected to a common node of the first capacitor and the second capacitor.

14. The plasma display apparatus of claim 10, wherein
the rest capacitors except at least one of the plurality of capacitors includes a first capacitor connected to the first electrode driver, and a second capacitor connected to the first capacitor, and
a capacitance of the second capacitor is greater than a capacitance of the first capacitor.

15. A driving method of a plasma display apparatus including an energy storing unit, a first electrode and a second electrode, comprising:
supplying or recovering an energy corresponding to a first voltage or second voltage supplied by the energy storing unit through the first electrode during an address period; and
supplying or recovering the energy corresponding to the second voltage supplied by the energy storing unit through the second electrode during a sustain period, wherein
a level of the first voltage is less than a level of the second voltage.

16. The driving method of claim 15, further comprising
supplying the energy corresponding to the second voltage to the first electrode, supplying a constant voltage to the first electrode, recovering the energy corresponding to the second voltage from the first electrode to the energy storing unit, and supplying a ground level voltage to the first electrode during the address period.

17. The driving method of claim 15, further comprising
supplying the energy corresponding to the first voltage to the first electrode, supplying a constant voltage to the first electrode, recovering the energy corresponding to the first voltage from the first electrode to the energy storing unit, and supplying a ground level voltage to the first electrode during the address period.

18. The driving method of claim 15, further comprising
supplying the energy corresponding to the first voltage to the first electrode, supplying the second voltage to the first electrode, recovering the energy corresponding to the first voltage from the first electrode to the energy storing unit, and
supplying a ground level voltage to the first electrode during the address period.
